(19) United States
(12) Patent Application Publication
(10) Pub. No.: US 2013/0287336 A1
(43) Pub. Date: Oct. 31, 2013

(54) OPTICAL SWITCH

(71) Applicants: Shih-Yuan Wang, Palo Alto, CA (US); Michael Renne Ty Tan, Menlo Park, CA (US); Wayne Victor Sorin, Mountain View, CA (US); Michael Schlansker, Los Altos, CA (US); Sagi Varghese Mathai, Berkeley, CA (US)

(72) Inventors: Shih-Yuan Wang, Palo Alto, CA (US); Michael Renne Ty Tan, Menlo Park, CA (US); Wayne Victor Sorin, Mountain View, CA (US); Michael Schlansker, Los Altos, CA (US); Sagi Varghese Mathai, Berkeley, CA (US)

(21) Appl. No.: 13/456,767

(22) Filed: Apr. 26, 2012

(51) Int. Cl. G02B 6/26

(52) U.S. Cl. 385/17

(57) ABSTRACT

An apparatus comprises a given multimode optical waveguide extending in a given direction. The apparatus also comprises another multimode optical waveguide extending in another direction and intersecting with the given multimode waveguide. The apparatus further comprises a bi-stable optical switch positioned at the intersection of the given multimode optical waveguide and the another multimode optical waveguide to redirect a multimode optical signal transmitted on the given multimode optical waveguide to the another optical waveguide in a redirection state and pass the multimode optical signal transmitted on the given multimode optical waveguide across the intersection of the given multimode optical waveguide and the another optical waveguide in a pass-through state. The bi-stable optical switch can comprise a gap extending diagonally from a given corner of the intersection of the given and the another optical multimode waveguides to an opposing corner of the intersection.

### BACKGROUND

An optical switch is a switch that enables signals in optical fibers or integrated optical circuits (IOCs) to be selectively switched from one circuit to another. An optical switch may operate by mechanical means, such as physically shifting an optical fiber to drive one or more alternative fibers, or by electro-optic effects, magneto-optic effects, or other methods.

### BRIEF DESCRIPTION OF THE DRAWINGS

FIG. 1 illustrates an example of a system for transmitting and receiving a multimode optical signal.

FIG. 2 illustrates an example of a waveguide assembly with an optical switch in a redirection state.

FIG. 3 illustrates an example of a waveguide assembly with an optical switch in a pass-through state.

FIG. 4 illustrates another example of a waveguide assembly with an optical switch in a redirection state.

FIG. 5 illustrates another example of a waveguide assembly with an optical switch in a pass-through state.

FIG. 6 illustrates an example of a cross-section of a waveguide.

FIG. 7 illustrates an example of a cross-section of an intersection of waveguides.

FIG. 8 illustrates an example of an optical switch.

FIG. 9 illustrates an example of a cross-section of an optical switch.

FIG. 10 illustrates still yet another example of a waveguide assembly.

FIG. 11 illustrates yet still another example of a waveguide assembly.

### DETAILED DESCRIPTION

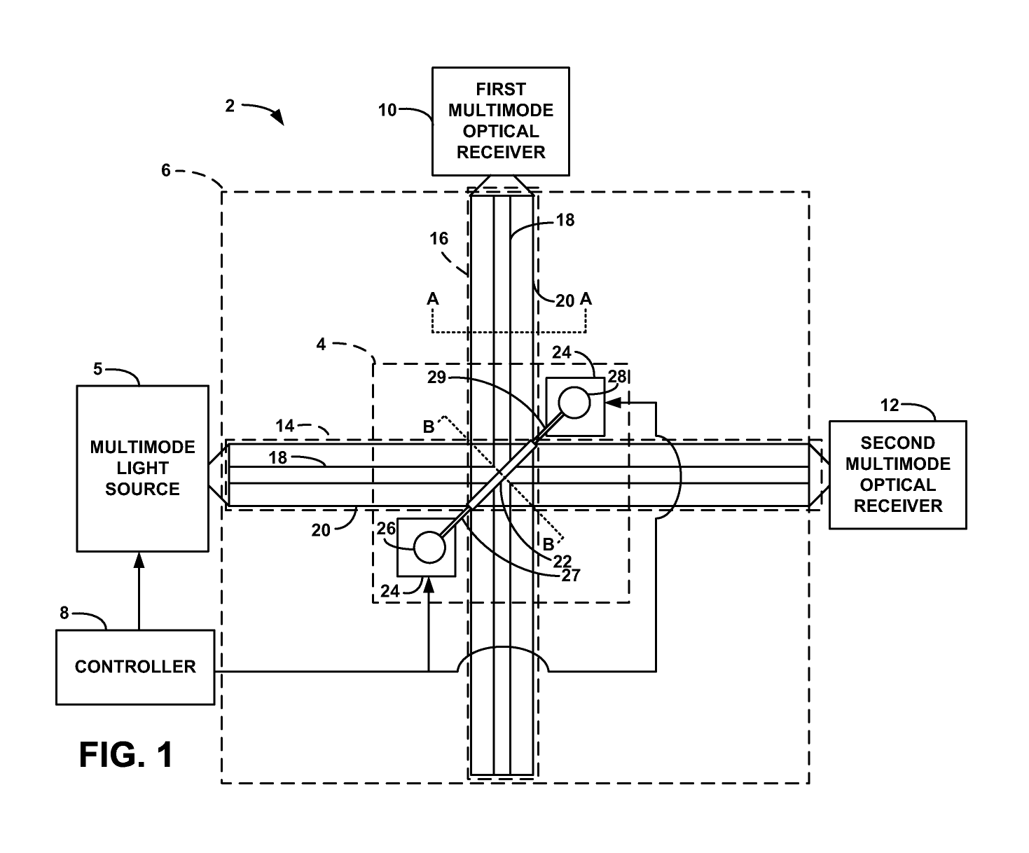

FIG. 1 illustrates an example of a system 2 that employs a multimode optical switch 4. The system 2 can include a multimode light source 5 that can transmit a multimode optical signal on an optical waveguide assembly 6. The multimode light source 5 could be implemented, for example as a multimode laser with a center wavelength of about 780 nm to about 980 nm. In one example, the multimode light source 5 could be implemented as a vertical-cavity surface-emitting laser (VCSEL). A VCSEL is a type of semiconductor laser diode with laser beam emission perpendicular from the top surface. In other examples, other multimode light sources could be employed. The multimode light source 5 could have a bandwidth up to about 10 nm. For instance, in some examples the multimode light source 5 can have a center wavelength of about 850 nm, such that the multimode light source 5 can provide a light signal with a wavelength that varies between about 845 nm to about 855 nm. In some examples, the multimode light source 5 can provide an optical data signal with a bandwidth up to about 40 gigabits per second (Gb/s). The multimode light source 5 can have an alignment tolerance of about 5 μm. Activation and/or deactivation of the optical data signal can be controlled by a controller 8. The controller 8 can be implemented, for example, as a microcontroller, a gate array, a computer or the like.

The multimode light source 5 can provide the optical data signal via the optical waveguide assembly 6 to a first multimode optical receiver 10 or a second multimode optical receiver 12. The first and second the multimode optical receivers 10 and 12 could be implemented, for example, as a photodetector. The first and second multimode optical receivers 10 and 12 can convert the optical data signal into an electrical data signal which could be provided to a computer system. In some examples, the multimode light source 5, the optical waveguide assembly 6 and the first and second multimode optical receivers 10 and 12 could be implemented on a common substrate (e.g., a circuit board) and separated by a distance of about 1 cm to about 1 m. In other examples, the optical waveguide assembly 6 could be implemented as an optical fiber such that the multimode light source 5 and the first and/or the second multimode optical receivers 10 and 12 could be separated by a distance of up to about 500 m.

The optical waveguide assembly 6 could be implemented as a crossbar of a first optical waveguide 14 and a second optical waveguide 16. Each of the first and second optical waveguides 14 and 16 can be multimode optical waveguides. Each of the first and second optical waveguides 14 and 16 can include a core 18 that has a specific index of refraction (e.g., 1.52). The core 18 of each of the first and second optical waveguides 14 and 16 could be surrounded by a cladding 20 with an index of refraction lower than the index of refraction of the core (e.g., 1.50). By such a configuration, multimode optical data signals can be carried on the first and second optical waveguides 14 and 16 with total internal reflection (TIR). The optical waveguide assembly 6 can include the optical switch 4 that can control the path of the optical data signal provided from the multimode light source 5 to the first multimode optical receiver 10 or the second multimode optical receiver 12. Moreover, the controller 8 can provide a control signal to change a state of the optical switch 4 between respective bi-stable operating states. In a redirection state, the optical data signal provided from the multimode light source 5 can be reflected to the first multimode optical receiver 10. In a pass-through state, the optical data signal provided from the multimode light source 5 can be passed through to the second multimode optical receiver 12.

The optical switch 4 can include a crossbar optical circuit where the first and second optical waveguides 14 and 16 intersect at a specific angle (e.g., about 10-90 degrees). The optical switch 4 can include switch surfaces that are substantially parallel and spaced apart from each other by a gap 22. The gap 22 could be about 2 μm to about 50 μm wide, for example.

The gap 22 can be defined, for example by a fillable void (e.g., a container) that has a first surface that extends through the cores 18 of the first and second waveguides 14 and 16. Moreover, in some examples, the fillable void can also extend through the claddings 20 of the first and second waveguides 14 and 16. The fillable void can also include a second surface separated from the first surface by a predefined define spacing that defines the gap 22. The fillable void, can for example, hold fluid or air, as explained herein. Moreover, the fillable void can be sealed with a stretchable thin solid polymer. In some examples, the fillable void could have a volume of about 3500 μm³ or more.

In some examples, the first and second surfaces of the fillable void can be substantially planer, such that the fillable void can have substantially vertical sidewalls, as described herein. The fillable void could be shaped as a rectangular prism. In some examples, the fillable void could be formed by employing optical lithography and/or imprinting (e.g., nano-imprinting) of the first and second waveguides 14 and 16.

In other examples, the first and second surfaces of the fillable void can be implemented as three dimensional (3D) curved surfaces that can re-collimate an optical beam passing there through. In some examples, the 3D curved surfaces could each be implemented as a paraboloid with a radius of curvature of about 0.1 cm to about 500 cm. Each paraboloid can be shaped to propagate an optical wave that is provided on or off an axis of propagation of the paraboloid. In such a situation, the fillable void could be fabricated by employing imprinting (e.g. nano-imprinting) techniques. In other examples, such a fillable void could be fabricated by employing mold injection techniques. For instance, in some examples, the 3D curved surfaces could be formed together with a preformed mold. In other examples, the 3D curved surfaces can be formed separately by the preformed mold and assembled in another mold for imprinting onto the first and second waveguides 14 and 16.

In the redirection state, the gap 22 could be filled with air or other material such that the optical data signal received from the multimode light source 5 is reflected to the first multimode optical receiver 10. In the pass-through state, the gap 22 can be filled with a liquid that substantially matches the index of refraction of the core 18 of the first and second optical waveguides 14 and 16, such that light received from the multimode light source 5 is passed through to the second optical receiver 12.

The liquid could be mobilized, for example, by a device 24 such as a piezoelectric device, a thermal device, or the like. For instance, in some examples, the liquid can be stored in a first reservoir 26. In an example where the liquid is mobilized by a thermal device, the first reservoir 26 can be heated in response to a control signal from the controller 8, and a thermocapillary effect can cause the liquid to move from the first reservoir 26 to the gap 22 and a second reservoir 28, thereby changing the optical switch 4 from the redirection state to the pass-through state. In some examples, the liquid can flow from the first reservoir into a first conduit 27 and then into the gap 22 and into a second conduit 29 and finally into the second reservoir 28. Additionally, the second reservoir 28 can be heated in response to the control signal from the controller 8 and the thermocapillary effect can cause the liquid to move from the gap 22 and the second reservoir 28 back to the first reservoir 26, thereby changing the optical switch 4 from the pass-through state to the redirection state. In some examples, the fluid can flow from the second reservoir 28 through to the second conduit 29 into the gap 22 through the first conduit 27 and finally into the first reservoir 26.

In an example where the liquid is mobilized by a piezoelectric device, actuation of the piezoelectric device by the controller 8 can apply pressure to the first reservoir 26, thereby forcing the liquid into the gap 22 and the second reservoir 28. Such a forcing of the liquid into the gap 22 than the second reservoir 28 can change the optical switch 4 from the redirection state to the pass-through state. Additionally, the piezoelectric device can be actuated by the controller 8 to apply pressure to the second reservoir 28 to force the liquid to move from the second reservoir 28 and the gap 22 to the first reservoir 26, thereby changing the optical switch 4 from the pass-through state to the redirection state. Moreover, in the present examples, the optical switch 4 can be bi-stable. Accordingly, once the optical switch 4 is in the redirection state or the pass-through state, the optical switch 4 remains in the same state without further application of heat or pressure. In some examples, the optical switch 4 can have a switching time of about 50 milliseconds (ms)to about 3 seconds or more.

By employment of the system 2, a low-cost, low loss optical waveguide assembly 6 with an optical switch 4 can be implemented. In particular, since the optical waveguide assembly 6 can carry multimode signals, significant design tolerances can be afforded in comparison to systems that employ single mode signals.

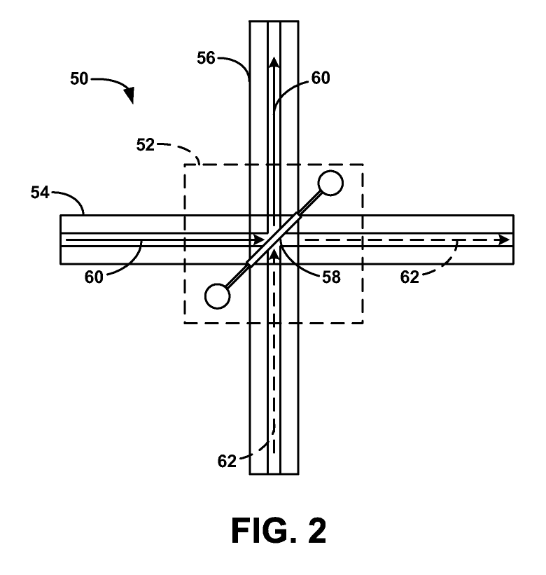

FIG. 2 illustrates an example of an optical waveguide assembly 50 that could be employed, for example, in the optical waveguide assembly 6 illustrated in FIG. 1. The optical waveguide assembly 50 can include an optical switch 52 that couples a first optical waveguide 54 and a second optical waveguide 56 at an intersection. The optical switch 52 can be a bi-stable optical switch. In the example of FIG. 2, the optical switch 52 is demonstrated in the redirection state. The optical switch 52 has a gap 58 (e.g., filled with air in the redirection state) with a width of about 2 μm to about 5 μm. The gap 58 can be positioned so that the center of the gap 58 is diagonally positioned across the intersection of the first and second waveguides 54 and 56. That is, the gap 58 connects opposing corners of the intersection of the first optical waveguide 54 and the second optical waveguide 56.

Since the gap 58 is about 2 μm to about 5 μm, the optical waveguide assembly 50 can carry duplex optical data signals. That is, the optical waveguide assembly 50 can concurrently carry a first optical data signal that is indicated by a solid arrow 60 in FIG. 2, as well as a second optical data signal that is indicated by a dashed arrow 62 in FIG. 2. The first and second optical data signals 60 and 62 can be implemented as multimode optical signals. In the present example, the first optical data signal 60 is redirected from the first optical waveguide 54 to the second optical waveguide 56. Similarly, the second optical data signal 62 is redirected from the second optical waveguide 56 to the first optical waveguide 54. The optical waveguide assembly 50 can redirect the first optical data signal 60 and the second optical data signal 62 with a power loss as low as about 0.1 dB.

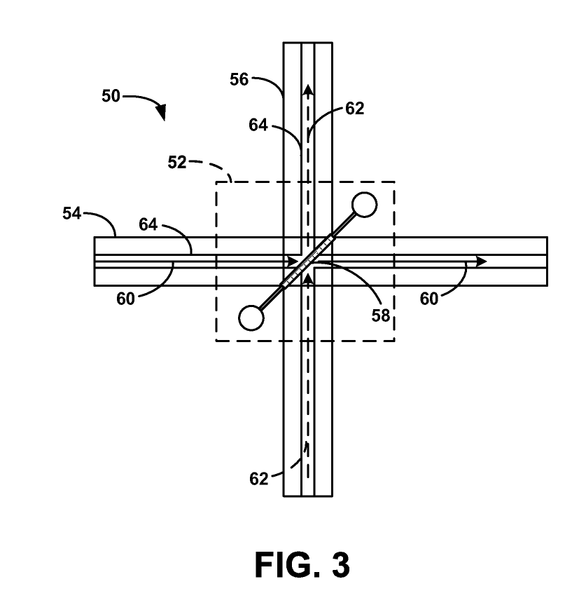

FIG. 3 illustrates an example of the optical waveguide assembly 50 illustrated in FIG. 2 with the optical switch 52 in the pass-through state. For purposes of simplification of explanation, the same reference numbers are used in FIGS. 2 and 3 to indicate the same structure. In the pass-through state, the gap 58 has been filled with a liquid that has an index of refraction substantially matching the index of refraction of a core 64 of the first and second optical waveguides 54 and 56. In such a situation, the first optical data signal 60 is passed through the intersection of the first optical waveguide 54 and a second optical waveguide 56 such that the first optical data signal 60 remains on the first optical waveguide 54. Similarly, the second optical data signal 62 is passed through the intersection of the first optical waveguide 54 and the second optical waveguide 56, such that the second optical data signal 62 remains on the second optical waveguide 56.

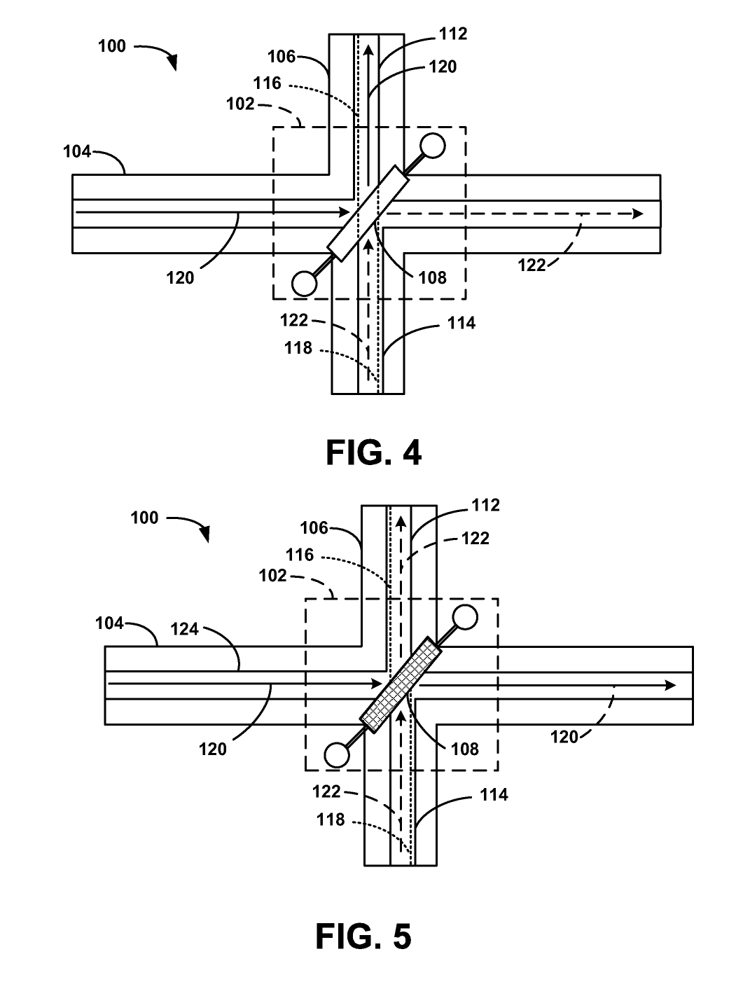

FIG. 4 Illustrates another example of an optical waveguide assembly 100 that could be employed, for example, as the optical waveguide assembly 6 illustrated in FIG. 1. The optical waveguide assembly 100 can include an optical switch 102 that couples a first optical waveguide 104 and a second optical waveguide 106. The optical switch 102 can be a bi-stable optical switch. The optical switch 102 is presented in the redirection state. The optical switch 102 can have a gap 108 (filled with air in the redirection state) with a width greater than 5 μm to about 50 rim. The gap 108 can be positioned so that a face of the gap 108 can be diagonally positioned across the intersection of the first and second optical waveguides 104 and 106 of the optical waveguide assembly 100. That is, the face of the gap 108 can connect opposing corners of the intersection of the first optical waveguide 104 and the second optical waveguide 106 (e.g., at about a forty-five degree angle relative to each of the optical waveguides, which can be aligned perpendicularly).

The second optical waveguide 106 can include a first core 112 and a second core 114 that can be offset about an axis relative to each other. The offset could be, for example, up to about 25 rim, such as about half a width of the gap 108. In FIG. 4, dotted lines 116 and 118 are included to depict the offset between the first core 112 and the second core 114. In some examples, the first core 112 and the second core 114 can be shaped to have mirror symmetry (e.g., reflective symmetry) with each other.

The optical waveguide assembly 100 can carry duplex optical data signals (e.g., can carry two optical signals concurrently). For instance, the optical waveguide assembly 100 can carry a first optical data signal, which is indicated by the arrow at 120 in FIG. 4. The optical waveguide can also carry a second optical data signal, which is indicated by arrow 122 in FIG. 4. The first and second optical data signals 120 and 122 can be carried concurrently by the optical waveguide assembly 100. The first and second optical data signals 120 and 122 can be multimode optical signals. In the present example, the first optical data signal 120 is redirected from the first optical waveguide 104 to the second optical waveguide 106 and the second optical data signal is redirected form the second optical waveguide 106 to the first optical waveguide 104. The optical waveguide assembly 100 can redirect the first and second optical data signals 120 and 122 with a power loss as low as about 0.1 dB.

FIG. 5 illustrates an example of the optical waveguide assembly 100 illustrated in FIG. 4 with the optical switch 102 in the pass-through state. For purposes of simplification of explanation, the same reference numbers are employed in FIGS. 4 and 5 to reference the same structure. In the pass-through state, the gap 108 has been filled with a liquid with an index of refraction that substantially matches the index of refraction of a core 124 of the first optical waveguide 104 and the first and second cores 112 and 114 of the second optical waveguides 106. In such a situation, the first and second optical data signal 120 and 122 can pass through the intersection of the first optical waveguide 104 and the second optical waveguide 106 such that the first optical data signal 120 remains on the first optical waveguide 104 and the second optical data signal 122 remains on the second optical waveguide 106.

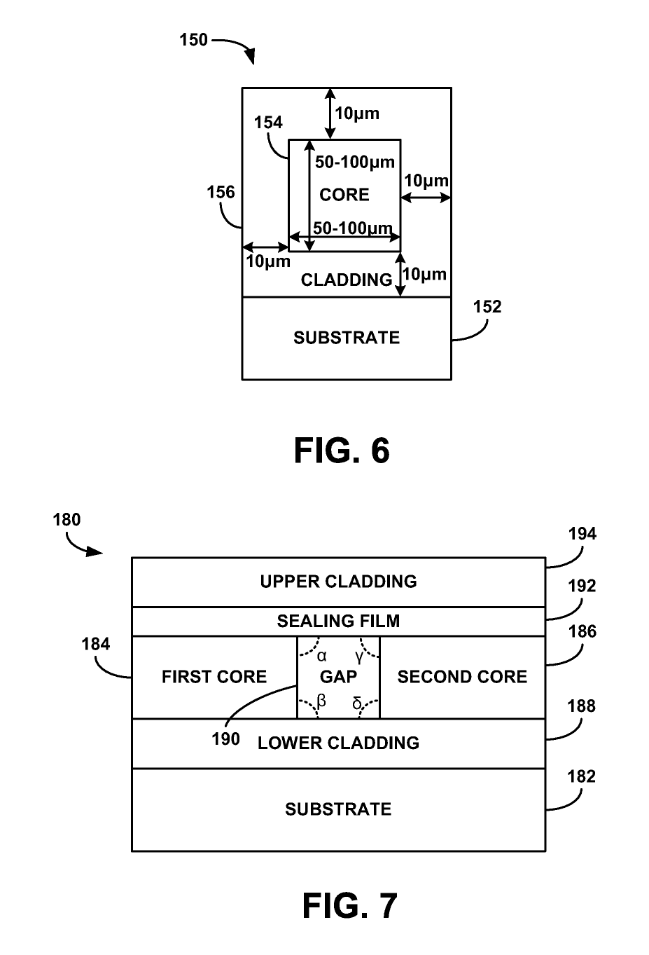

FIG. 6 illustrates an example of a cross-section taken along lines A-A of FIG. 1 depicting an optical waveguide 150 that could be employed in the optical waveguide assemblies 6, 50, 100 and 130 illustrated in FIGS. 1-5 as a first and/or a second optical waveguide. The optical waveguide 150 can be a multimode optical waveguide. The optical waveguide can include a substrate 152 that could be implemented, for example as a reinforced fiberglass such as FR-4, silicon (Si), glass or the like. The optical waveguide 150 can be stacked on the substrate 152. In one example, the optical waveguide 150 can be a rectangular optical waveguide with a rectangular core 154 with height and width dimensions of about 50-100 μm×50-100 μm. The core 154 can have an index of refraction (‘n’) of about 1.52. The core 154 can be formed of a polymer such a siloxane polymer. Moreover, the core 154 can be surrounded by a cladding 156 that extends about 10 μm or more on each side of the core 154. The cladding 156 can also be formed of a polymer. The cladding 156 can have an index of refraction (n) lower than that of the core 154, such as about 1.50. By employing the optical waveguide 150 in this manner, multimode signals carried on the optical waveguide 150 can be propagated through the optical waveguide 150 with TIR.

FIG. 7 illustrates an example of a cross section taken along lines B-B of FIG. 1 depicting an intersection 180 of a first and second waveguide. The intersection 180 can be stacked on a substrate 182, such as FR-4, silicon, glass or the like. The intersection 180 can include a first core 184 of the first waveguide and a second core 186 of the second waveguide. The first core 184 and the second core 186 can have substantially matching indices of refraction (e.g., about 1.52). The first core 184 and the second core 186 can overlay a lower cladding 188 that has a lower index of refraction than the first core 184 and the second core 186 (e.g., about 1.50). The first core 184 and the second core 186 can be separated by a gap 190, which can be a fillable void. In a redirection state, the gap 190 can be filled with air, and in a pass-through state, the gap 190 can be filled with a fluid that has an index of refraction that matches the index of refraction of the first core 184 and the second core 186.

The gap 190 can have a rectangular prism shape, with a rectangular cross section, as illustrated. The gap 190 can include four angles, α, β, β and δ at the corners of the gap 190. Each of the angles α, β, γ and δ can be substantially equal. Moreover, each of the angles α, β, γ and δ can about 86 degrees to about 94 such that the gap 190 can have substantially vertical sidewalls, which sidewalls are the boundary between the first core 184 and the gap 190 as well the boundary between the second core 186 and the gap 190. Providing each angle α, β, γ and δ at or near 90 degrees can reduce loss of a multimode optical data signal transmitted through or redirected by the gap 190. A sealing film 192 can overlay the gap 190 as well as the first core 184 and the second core 186. The sealing film 192 can be implemented as a stretchable thin solid polymer. An upper cladding 194 can overlay the sealing film 192. The upper cladding 194 can have an index of refraction that matches the index of refraction of the lower cladding 188. In some examples, a focusing element such as a grating, an aperiodic grating (e.g., a zone plate and/or a Fresnel lens) or other nanostructure can be adhered to the first and/or second surfaces of the gap 190 to facilitate collimation of the optical beam to further reduce loss. In such a situation, the focusing element can be formed by employing imprinting and/or mold and injection techniques.

The gap 190 can be formed by employing optical lithography and/or imprinting techniques. By employing optical lithography and/or imprinting techniques, the corners angles α, β, γ and δ can be accurately formed with angles between about 86 degrees to about 94 degrees to ensure that the gap 190 has substantially vertical side walls. Moreover, optical lithography and/or imprinting techniques can be performed in batch processing techniques at a relatively low cost.

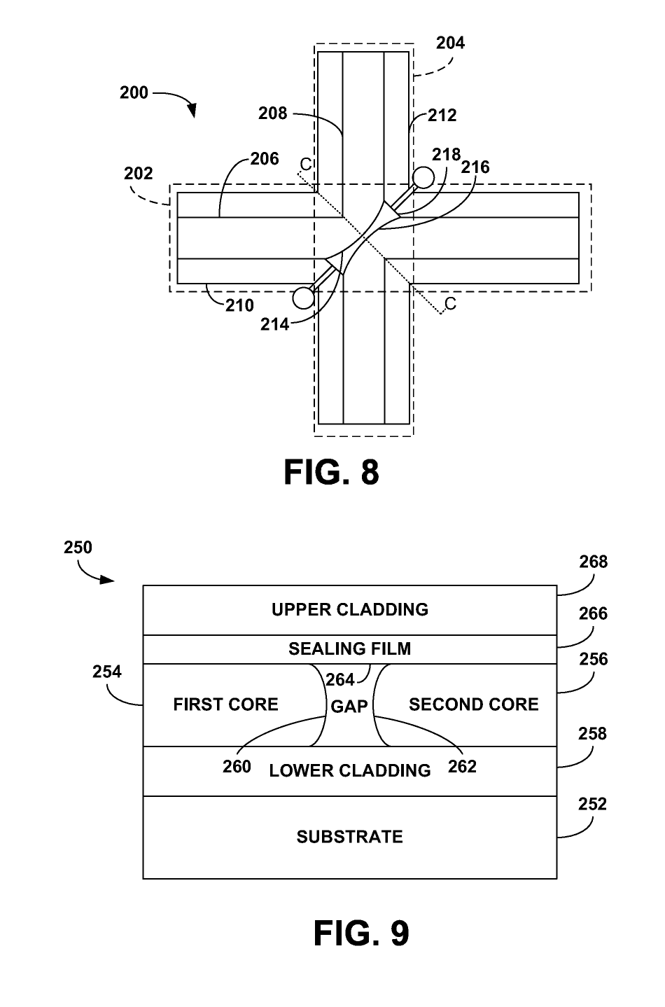

FIG. 8 illustrates an optical switch 200 that could be employed as the optical switch 4 illustrated in FIG. 1. The optical switch 200 can have a redirection state and a pass-through state. The optical switch 200 can carry duplex data signals. The optical switch 200 can be positioned at an intersection between a first waveguide 202 and a second waveguide 204. Each of the first and second waveguides 202 and 204 can include cores 206 and 208 that have a first index of refraction (e.g., about 1.52). The cores 206 and 208 can be surrounded by respective claddings 210 and 212 that have a second index of refraction that is lower than the first index of refraction (e.g., about 1.5). The optical switch 200 can include a first 3D curved surface 214 and a second 3D curved surface 216 that can be separated by a gap 218. Each of the first and second 3D curved surfaces 214 and 216 can be implemented as paraboloids with a radius of curvature of about 0.1 cm to about 500 cm. In some examples, the first and second 3D curved surfaces 214 and 216 can propagate an optical wave that is provided either on or off an axis of propagation of the 3D curved surfaces 214 and 216.

The gap 218 can be a fillable void. The gap 218 can have a width of about 1 μm to about half a width of the cores 206 and 208 (e.g., about 50 μm). In the redirection state of the optical switch 200, the gap 218 can be filled with air, such that a data signal propagating on the first optical waveguide 202 is redirected to the second optical waveguide 204 and vice versa. In the pass-through state of the optical switch 200, the gap 218 can be filled with a fluid that has substantially the same index of refraction as the cores 206 and 208. Accordingly, in the pass-through state, optical data signals propagating on the first or second optical waveguides 202 and 204 pass through the gap 218 and remain propagating on the same optical waveguide. The first and/or second 3D curved surfaces 214 and 216 of the gap 218 can facilitate collimation of the optical data signals thereby reducing and/or minimizing optical losses further along the first and second optical waveguides 202 and 204.

FIG. 9 illustrates an example of a cross section taken along lines C-C of FIG. 8 depicting an intersection 250 of a first and second waveguide. The intersection 250 can be stacked on a substrate 252, such as FR-4, silicon, glass or the like. The intersection 250 can include a first core 254 of the first waveguide and a second core 256 of the second waveguide. The first core 254 and the second core 256 can have substantially matching indices of refraction (e.g., about 1.52). The first core 254 and the second core 256 can overlay a lower cladding 258 that has a lower index of refraction than the first core 254 and the second core 256 (e.g., about 1.50). The first core 254 and the second core 256 can have 3D curved surfaces 260 and 262 that are separated by a gap 264, which can be a fillable void. The gap 264 can be bound by the 3D curved surfaces (or regions) 260 and 262 and can have an hourglass shape, as illustrated. The gap 264 can have a width (distance between the first and second cores 254 and 256) of about 1 μm to about half a width of the first and second cores 254 and 256 (e.g., about 50 μm). In a redirection state, the gap 264 can be filled with air, and in a pass-through state, the gap 264 can be filled with a fluid that has an index of refraction that matches the index of refraction of the first core 254 and the second core 256.

A sealing film 266 can overlay the gap 264 as well as the first core 254 and the second core 256. The sealing film 266 can be implemented as a stretchable thin solid polymer. An upper cladding 268 can overlay the sealing film 266. The upper cladding 268 can have an index of refraction that matches the index of refraction of the lower cladding 258.

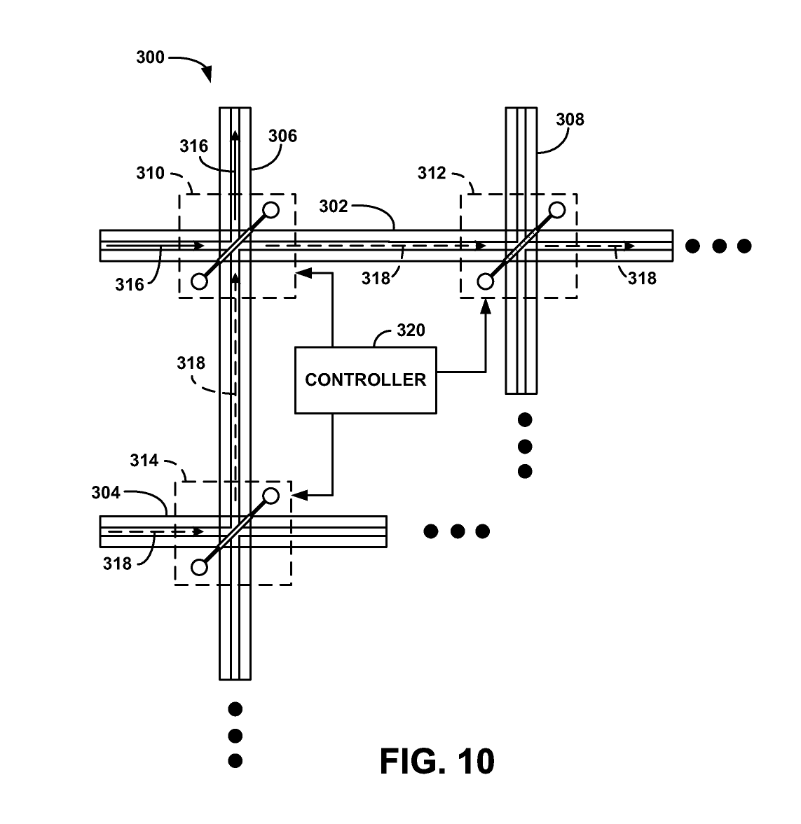

FIG. 10 illustrates an example of an optical waveguide assembly 300 that includes N number of optical waveguides 302 and 304 by M number of optical waveguides 306 and 308 (N×M), where N and M are integers greater than or equal to one. Each of the N number of optical waveguides 302 and 304 can extend in a first direction, and each of the M number of optical waveguides 306 and 308 can extend in a second direction. Each of the N number of optical waveguides 302 and 304 can intersect with each of the M number of optical waveguides 306 and 308 at an angle between about 10 and about 90 degrees. Each intersection can include an optical switch 310, 312 and 314. Thus, there can be M×N number of optical switches 310, 312 and 314. Each of the M×N number of optical switches 310, 312 and 314 can be bi-stable optical switches. The present example illustrates three optical switches 310, 312 and 314. Each optical switch 310, 312 and 314 could be implemented, for example, in a manner similar to the optical switch 4 illustrated in FIG. 1. In the present example, each optical switch 310, 312 and 314 can support duplexing (e.g., carry two concurrent optical data signals). Thus, each optical switch 310, 312 and 314 can have a gap with a width of about 2 μm to about 50 μm as shown and described with respect to FIGS. 2-9. In other examples, each optical switch 310, 312 and 314 can carry a single optical data signal. The optical waveguide assembly 300 can redirect or pass-through multimode optical data signals. In the present example, two different optical data signals are depicted. The first optical data signal is depicted with a solid arrow at 316, while the second optical data signal is depicted with a dashed arrow at 318.

Each optical switch can be independently controlled by a controller 320, such that each optical switch 310, 312 and 314 can be in either a redirection state or a pass-through state. The controller 320 could be implemented, for example, as hardware (e.g., an application-specific integrated circuit chip) software (e.g., machine-readable instructions executing on the microprocessor), or a combination of both (e.g., firmware). In the present example, three different optical switches 310, 312 and 314 are illustrated. Each optical switch 310, 312 and 314 can be implemented as a bi-stable optical switch. The first and third optical switches 310 and 314 are depicted to be in the redirection state in response to controls signals from the controller. The second optical switch 312 is depicted to be in the pass-through state in response to a control signal from the controller. Accordingly, in the present example, the first optical data signal 316 is redirected by the first optical switch 310. Additionally, the second optical data signal 318 is redirected by the third optical switch 314 and the first optical switch 310 and passed-through by the second optical switch 312.

Employment of the optical waveguide assembly 300 illustrated in FIG. 10 allows for communication between endpoints (e.g., transmitters and receivers) coupled to the optical waveguide assembly 300. Moreover, by changing the state of the optical switches 310, 312 and 314, each incoming optical signal can be redirected to multiple different optical receivers. Thus, the optical waveguide assembly 300 could be implemented in a data switch to provide communication between servers. Moreover, since the optical waveguide assembly is multimode, the optical waveguide assembly can support optical data signals that carry up to about 40 Gb/s.

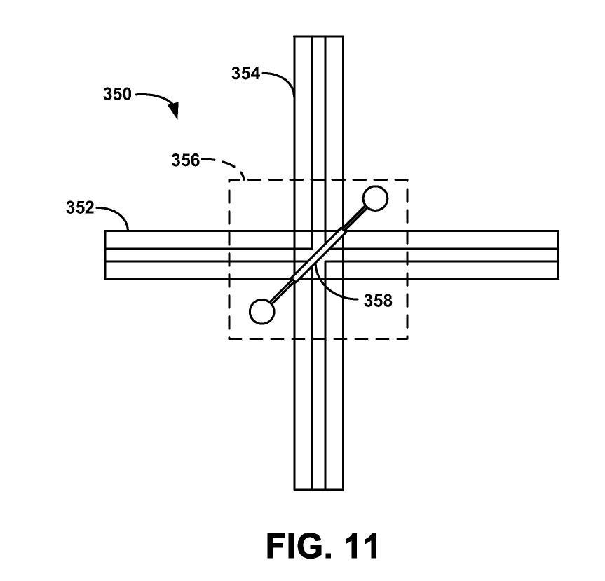

FIG. 11 illustrates yet another example of an optical waveguide assembly 350. The optical waveguide assembly 350 can comprise a given multimode optical waveguide 352 extending in a given direction. The optical waveguide assembly 350 can also comprise another multimode optical waveguide 354 extending in another direction and intersecting with the given multimode optical waveguide 352. The optical waveguide assembly 350 can further comprise a bi-stable optical switch 356 positioned at the intersection of the given multimode optical waveguide 352 and the other multimode optical waveguide 354. The optical switch 356 can redirect a multimode optical signal transmitted on the given multimode optical waveguide 352 to the other multimode optical waveguide 354 in a redirection state and pass the multimode optical signal transmitted on the given multimode optical waveguide 352 across the intersection of the given multimode optical waveguide 352 and the other multimode optical waveguide 354 in a pass-through state. The bi-stable optical switch 356 can comprise a gap 358 extending diagonally from a given corner of the intersection of the given and the another multimode optical waveguides 352 and 354 to an opposing corner of the intersection the gap 358 can have substantially vertical sidewalls or the gap can be bound by two spaced apart three-dimensional (3D) curved regions of the intersection.

Where the disclosure or claims recite “a,” “an,” “a first,” or “another” element, or the equivalent thereof, it should be interpreted to include one or more than one such element, neither requiring nor excluding two or more such elements. Furthermore, what have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims.

What is claimed is:

1. An apparatus comprising:
a given multimode optical waveguide extending in a given direction;
another multimode optical waveguide extending in another direction and intersecting with the given multimode optical waveguide at an intersection; and
a bi-stable optical switch at the intersection of the given multimode optical waveguide and the another multimode optical waveguide to:
redirect a multimode optical signal transmitted on the given multimode optical waveguide to the another optical waveguide in a redirection state; and
pass the multimode optical signal transmitted on the given multimode optical waveguide across the intersection of the given multimode optical waveguide and the another optical waveguide in a pass-through state;
wherein the bi-stable optical switch comprises a gap extending diagonally from a given corner of the intersection of the given and the another optical multimode waveguides to an opposing corner of the intersection, the gap having substantially vertical sidewalls or the gap being bound by two spaced apart three-dimensional (3D) curved regions of the intersection.

2. The apparatus of claim 1, wherein each of the given and the another multimode waveguides comprise a core at a given refractive index surrounded by cladding with another refractive index, lower than the given refractive index.

3. The apparatus of claim 2, wherein the core of the given optical multimode waveguide and the another optical waveguide comprises a polymer material.

4. The apparatus of claim 2, wherein each of the 3D curved regions of the intersection have a substantially paraboloidal shape.

5. The apparatus of claim 2, wherein the core of the given optical multimode waveguide and the another optical multimode waveguide has a width of about 50 μm or greater, and a height of about 50 μm or greater.

6. The apparatus of claim 2, wherein the optical switch comprises a reservoir for holding a fluid with an index of refraction that substantially matches the index of refraction of the core of the given optical multimode waveguide and the another optical multimode waveguide, such that the given and the another multimode optical waveguides carry multimode optical signals through total internal reflection (TIR).

7. The apparatus of claim 6, wherein the optical switch comprises a heater to heat the reservoir, thereby switching the optical switch from one of the redirection state and the pass-through state to the another of the redirection state and the pass-through state upon actuation of the heater.

8. The apparatus of claim 6, wherein the optical switch comprises a piezoelectric device to apply pressure to the reservoir, thereby switching the optical switch from one of the redirection state and the pass-through state to the another of the redirection state and the pass-through state upon actuation of the piezoelectric device.

9. The apparatus of claim 1, wherein the a given vertical sidewall of the gap is bound by a face of a core of the given optical multimode waveguide and another vertical sidewall of the gap is bound by a face of a core of the another optical multimode waveguide, wherein the given and the another vertical sidewalls intersect with a cladding at an angle between about 86 degrees and about 94 degrees.

10. The apparatus of claim 9, wherein the gap is filled with air in the redirection state and the fluid in the pass-through state.

11. The apparatus of claim 1, wherein the gap has a width greater than 5 μm, and a given and another core of the another optical multimode waveguide are offset about an axis by a given distance.

12. The apparatus of claim 9, wherein the given distance is about half the width of the gap.

13. A system comprising:
N number of multimode optical waveguides extending in a given direction, where N is an integer greater than or equal to one;
M number of multimode optical waveguides extending in another direction and each of the M number of multimode optical waveguides intersecting with each of the N number of multimode waveguides, where M is an integer greater than or equal to one; and
N×M number of bi-stable optical switches, each optical switch being positioned at a given intersection of one of the N number of multimode optical waveguides and the M number of multiple waveguides, each optical switch to:
redirect a multimode optical signal carried on one of the N number of multimode optical waveguides to one of the M number of multimode optical waveguides in a redirection state; and
pass the multimode optical signal carried on one of the N number of multimode optical waveguides across the given intersection in a pass-through state,
wherein each bi-stable optical switch comprises a gap extending diagonally from a given corner of the given intersection to an opposing corner of the given intersection, the gap having substantially vertical sidewalls or the gap being bound by two spaced apart three-dimensional (3D) curved regions of the given intersection.

14. The system of claim 13, further comprising a controller to control the state of each of the M×N number of optical switches.

15. A system comprising:
N number of multimode optical waveguides extending in a given direction, where N is an integer greater than or equal to one;
M number of multimode optical waveguides extending in another direction and each of the M number of multimode optical waveguides intersecting with each of the N number of multimode waveguides, where M is an integer greater than or equal to one, wherein each of the N and M number of optical waveguides comprises:
a core of polymer material with a given index of refraction and a rectangular shape having two cross-sectional dimensions each of about 50 μm or greater;
a cladding surrounding the core that has a index of refraction lower than the index of refraction of the core, such that multimode optical signals are carried on the N and M number of optical waveguides through total internal reflection;
N×M number of bi-stable optical switches, each optical switch being positioned at a given intersection of one of the N number of multimode optical waveguides and the M number of multiple waveguides, each optical switch to:
redirect a multimode optical signal carried on one of the N number of multimode optical waveguides to one of the M number of multimode optical waveguides in a redirection state;
pass the multimode optical signal carried on one of the N number of multimode optical waveguides across the given intersection in a pass-through state;
each optical switch comprising:
a gap that separates the optical waveguides at the given intersection, the gap being an filled with air in the redirection state and a fluid with an index of refraction substantially matching the index of refraction of a core of optical waveguides at the given intersection, the gap having substantially vertical sidewalls or the gap being bound by two spaced apart three-dimensional (3D) curved regions of the given intersection;
a reservoir to store the fluid;
a device to force the fluid between the gap and the reservoir to change the state of the optical switch between the redirection state and the pass-through state;
a vertical-cavity surface-emitting laser (VCSEL) coupled to one of the N or M number of multimode optical waveguides to transmit the optical signal;
an optical receiver coupled to another of the N or M number of multimode optical waveguides to receive the optical signal; and
a controller to control the state of each of the M×N number of optical switches.
